(19) United States
(12) Patent Application Publication
(10) Pub. No.: US 2021/0262501 A1
(43) Pub. Date: Aug. 26, 2021

(54) MAGNETIC AND MECHANICAL INTEGRATED ANCHORAGE DEVICE

(71) Applicant: Claudio VICENTELLI, Alghero (IT)

(72) Inventor: Claudio VICENTELLI, Alghero (IT)

(21) Appl. No.: 17/256,306

(22) PCT Filed: Jun. 25, 2019
(86) PCT No.: PCT/IB2019/055340

§ 371 Date: Dec. 28, 2020

(30) Foreign Application Priority Data
Jun. 26, 2018 (IT) 102018000006673

(51) Int. Cl. F16B 5/00; H01F 7/02

(52) U.S. Cl. CPC F16B 5/0008; H01F 7/02; F16B 5/0092

(57) ABSTRACT

An integrated magnetic and mechanical device for anchoring structural elements of an assembly. The device comprises a first and a second junction element partially or totally made of ferromagnetic material, which can be connected to respective structural elements of the assembly, and at least one magnetic core having end anchoring faces each provided with at least one magnetic pole, in which the magnetic core extends along a longitudinal axis and anchors to bottom walls of the junction elements. The junction elements and the magnetic core are also configured themselves, or provided with mechanical interconnection members so as to increase, in combination with the magnetic anchorage, the resistance to external stresses and to prevent any relative movement between the junction elements in an assembled condition.

This application is a § 371 National Stage Entry of International Patent Application No. PCT/IB2019/055340 filed Jun. 25, 2019. Application No. PCT/IB2019/055340 claims priority of IT 102018000006673 filed Jun. 26, 2018. The entire content of these applications is incorporated herein by reference.

### BACKGROUND OF THE INVENTION

The present invention relates to a magnetic and mechanical integrated device for anchoring structural elements of an assembly, suitable for any field of use, such as to allow a synergetic action between magnetic anchoring forces and mechanical connection members, so as to offer in addition to the magnetic one a greater resistance to external stresses, for example to shear, traction, bending, and/or torsion forces, more effectively preventing in one assembled condition one or more relative movements between the structural elements of the assembly, maintaining the typical advantages of magnetic anchorage such as, in particular, the speed for assembling/disassembling the structural elements of the assembly, integrated with the advantages of the mechanical connection system.

### STATE OF ART

The use of magnetic anchoring devices, as an alternative to mechanical or other type of devices, has been variously proposed exploiting the attraction forces generated by magnetic modules variously configured and suitably fixed to structural elements to be connected of any type of assembly.

Magnetic anchoring devices suitable for the construction of assemblies, for example, are described in EP1742715 and EP2125132 or WO 2008/077575 of the same applicant, in WO2011065736 and in EP2905482.

In particular EP1742715 relates to a system for the construction of any assembly in the field of the toy, in which use is made of modular blocks in non-magnetic material, in combination with a plurality of magnetic elements consisting solely of metal balls and magnetic bars removably housed in each of the modular blocks of the assembly; the modular blocks and the magnetic elements are also configured with shoulder surfaces suitable for contrasting the magnetic anchoring forces.

WO2011065736 in turn relates to an assembly for the construction of furniture, or assemblies, in which simple permanent magnets are used, housed in respective seats of one of the structural elements to be connected, in which each magnet engages a metal plate fixed to the another structural element of the furniture or assembly.

Although magnetic anchoring devices of the aforementioned type allow the construction of any type of assembly in which the various component parts are magnetically anchored to each other, however such devices suffer from some drawbacks due to the fact that the magnetic anchoring force is often unsuitable for resisting to external forces that are locally opposed only by the same magnetic anchoring forces. It follows that an assembly whose component parts are assembled solely by magnetic anchoring forces, is unstable or easily deformable under the action of external stresses.

To partially overcome these drawbacks EP 2125132 shows an assembly composed of magnetic anchoring bars and metal balls, in combination with additional mechanical junction elements constituting parts structurally and functionally separate from the magnetic anchoring bars.

The use of magnetic and mechanical anchoring devices which are structurally functionally separated, according to EP 2125132, if on the one hand it allows a great freedom and ease of making simple or complex reticular structures, of small or large dimensions, constituted by a plurality of magnetic bars and metal balls mutually magnetically anchored, on the other hand it requires the use of an additional mechanical system consisting of two tubular elements arranged at 90°, integral with each other so as to prevent any angular movement between two or more magnetic bars anchored to a same metal ball, or to different metal balls of a reticular structure, in which the magnetic bars must be previously inserted in the tubular elements of the mechanical connection system.

The use of magnetic bars and metal balls, in combination with an additional mechanical connection system, according to EP2125132, in addition to constructively and functionally complicating the system and the assembly operations, is in fact completely unsuitable for connecting and assembling structural elements of any type of assembly; the document is completely silent neither provides any useful information.

Finally, EP2905482, which is the state of the art closest to the present invention, illustrates a mechanical connection device for assembling structural elements according to the preamble of claim 1, wherein only mechanical connection members of the male and female type are used; the device comprises a first cup-shaped connection member and a second elongated connection member configured with elastic fingers which snap engage with an internal shoulder of the first connection member; a safety magnetic core is slidably housed in one of the connection members and is magnetically drawn into an advanced position towards the other connection member, in which it blocks the disengagement of the elastic fingers in the assembled condition. The disengagement between the two mechanical connection members can be done by acting from the outside with an electromagnetic device to make the safety magnetic core move back, thus allowing the disengagement of the elastic fingers from the shoulder inside the first connection member. Therefore in EP2905482 there is no integration between the mechanical connection force and the action of the magnetic safety core.

### OBJECTS OF THE INVENTION

The general object of the present invention is to provide an integrated magnetic and mechanical anchoring device between different parts of any type of assembly, in which use is made of a magnetic anchoring system which is structurally and functionally integrated with a mechanical connection system such that the two systems structurally and functionally integrated in a specific type of joint, act synergistically to increase the resistance to external stresses, opposing one or more relative movements between structural elements of an assembly, maintaining the typical advantages of a magnetic anchorage, integrated with those of the mechanical connection system.

A further object of the invention is to provide an integrated magnetic and mechanical anchoring device which is functionally and structurally integrated, in which use is made of a magnetic anchoring member and a mechanical interconnection system which can be differently configured, depending on specific needs and the type of assembly to be assembled.

In this way, great freedom of design and ease assembling of any type of assembly to be made is allowed.

### BRIEF DESCRIPTION OF THE INVENTION

These and other objects can be achieved by means of an integrated magnetic and mechanical anchoring device having the general characteristics of the present invention.

More precisely, according to the invention, an integrated magnetic and mechanical anchoring device has been provided, suitable for disengagingly connecting structural elements of an assembly, the anchoring device including:
a first and a second junction element configured with a bottom wall and with a peripheral wall, connectable to a respective one of the structural elements of the assembly;
the first and the second junction element also being provided with interconnection elements which can be engaged and disengaged from each other in a direction of a longitudinal axis of at least one of the junction elements,
wherein at least the bottom wall of the first and second junction element is made of magnetically conductive material;
wherein a permanent magnetic anchor core provided with magnetic poles at opposite ends, extends in the direction of the longitudinal axis and is magnetically anchorable to the bottom walls of the first and second junction element; and
wherein the first and the second junction element, and the magnetic core are provided with respective peripheral contact interfaces configured to increase, in combination with the magnetic forces, the resistance to external stresses and to prevent relative movements between the first and the second junction element, in an assembled condition.

### BRIEF DESCRIPTION OF THE DRAWINGS

The general characteristics and some preferential embodiments of the integrated magnetic and mechanical anchoring device between structural parts of an assembly, according to the present invention will be more fully described below, with reference to the drawings, in which:

FIG. 1 shows a cross sectional view of a first solution of the integrated magnetic and mechanical anchoring device;

FIG. 1A schematically shows the magnetic and mechanical forces of the anchoring device according to the present invention;

FIG. 2 shows a cross-sectional view of a second solution;

FIG. 3 partially shows in section and partially in view a third solution;

FIG. 4 shows a fourth solution in section;

FIG. 5 shows an exploded view, partially in section, of a fifth solution;

FIG. 6 shows an exploded perspective view of a sixth solution;

FIG. 7 shows an exploded perspective view of a seventh solution;

FIG. 8 shows an exploded perspective view of an eighth solution;

FIG. 9 shows a perspective view of a first assembly of three linear junction elements;

FIG. 10 shows a perspective view of a second assembly of linear junction elements;

FIG. 11 shows, partially in section, a further solution;

FIG. 12 schematically shows the use of an intermediate connection member;

FIG. 13 schematically shows the use of a second intermediate connection member;

FIG. 14 shows, by way of example, a generic combination of structural elements of an assembly, variously configured, connectable by a magnetic and mechanical integrated device according to the invention;

FIG. 15 shows a perspective view of a first type of magnetic module, with inversion or flux deviation, suitable for a magnetic and mechanical anchoring device according to the invention;

FIG. 16 is a cross-sectional view according to the line 16-16 of FIG. 15;

FIG. 17 is a cross-sectional view according to the line 17-17 of FIG. 16;

FIG. 18 shows a perspective view, partially in section, of a possible first embodiment of a permanent magnetic core;

FIG. 19 shows a perspective view, partially in section, of a possible second embodiment of a permanent magnetic core.

### DETAILED DESCRIPTION OF THE INVENTION

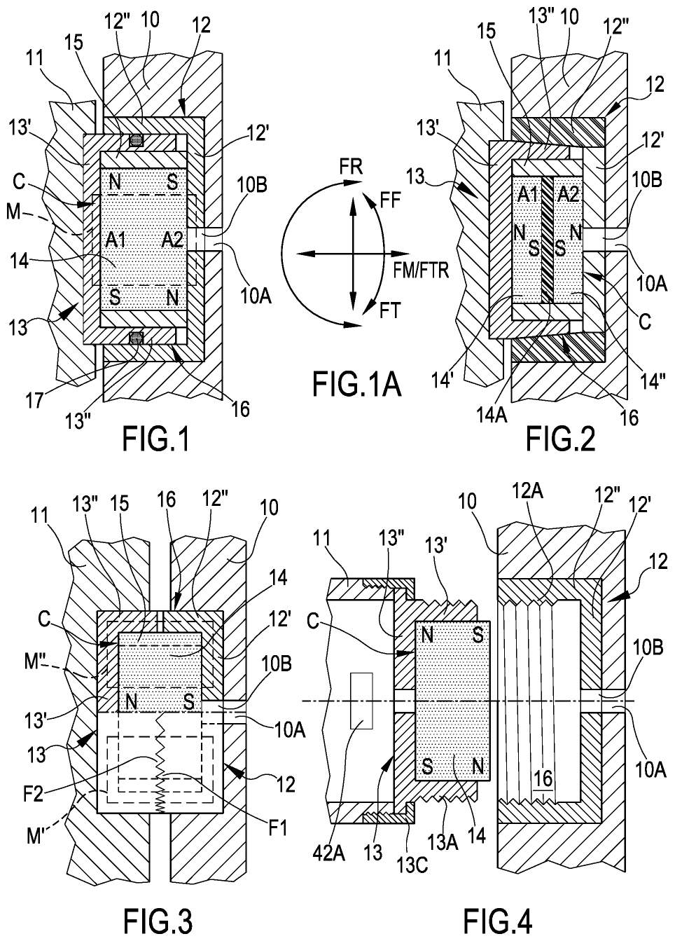

With reference to FIG. 1, the general characteristics of the integrated magnetic and mechanical anchoring device according to the invention will be described, as well as a first embodiment.

According to the general features of the invention, the integrated magnetic and mechanical anchoring device must be suitable to provide magnetic anchoring forces in an axial direction, in addition to mechanical connection forces to increase the ability of the device to withstand one or more external tensile, shear, bending and torsional stresses between structural elements however configured of any type of assembly.

In the specific case of FIG. 1 a magnetic and mechanical integrated device for anchoring two structural elements 10, 11 of a generic assembly has been shown; the anchoring device shown comprises a first hollow junction element consisting of a first cup shaped element 12 fixedly fastened in a corresponding seat of the structural element 10, and a second hollow junction element consisting of a second cup-shaped element 13 fixedly fastened in a corresponding seat of the other structural element 11, in the assembled condition of FIG. 1. The cup shaped element 12 is configured with a bottom wall 12′ in magnetically conductive material, and a peripheral wall 12″ integral with the bottom wall 12′; similarly, the cup-shaped element 13 is configured with a bottom wall 13′in magnetically conductive material, and a peripheral wall 13″ integral with the bottom wall 13′.

The two cup-shaped elements 12 and 13, partially or totally in a magnetically conductive material, in the specific case can be axially insertable into one another, and are configured to form a closed space between them, in the assembled condition, to house a permanent magnetic anchor core C including at least one magnet 14 and an outer skirt 15 of magnetically non-conductive material; the magnetic core C, as schematically shown, has two opposite anchoring faces A1, A2 each configured with at least one magnetic pole N or S, two poles of opposite polarity N, S in the case shown. The magnetic core C, in the assembled condition of FIG. 1, extends along a longitudinal axis between the bottom walls 12″, 13″ of the two cup-shaped elements 12, 13 or other part in magnetically conductive material of a respective cup-shaped element 12, 13, or equivalent junction element.

The two cup-shaped elements 12 and 13 for housing the magnetic anchor core C are further configured with additional mechanical means suitable to increase the resistance to external stresses and to prevent one or more relative movements between the same cup-shaped elements 12 and 13, or equivalent junction element, consequently between the structural elements 10 and 11 of the assembly shown.

In particular, the two cup-shaped elements 12, 13 for housing the magnetic anchor core C are configured themselves, and/or in combination with the magnetic core C to provide magnetic anchoring forces and additional mechanical connection forces of the type indicated below by the double arrows in FIG. 1A, in particular:
FM—magnetic anchorage force between the two junction elements, in the direction of a longitudinal axis of the magnetic core C, to which a mechanical tensile strength FTR can be added;
FT—additional mechanical strength of resistance to a cutting action, in a direction orthogonal to the longitudinal axis of the magnetic core C;
FF—additional mechanical strength of resistance to a bending action between the two junction elements with respect to the longitudinal axis of the magnetic core C;
FR—additional mechanical strength of resistance to a rotation between the two junction elements, according to the longitudinal axis of the magnetic core C.

According to the example of FIG. 1, the magnetic anchorage force FM is given by the action of the magnetic core C, whose magnetic flux M is linked with the two cup-shaped elements 12, 13; otherwise the additional mechanical forces of cut resistance FT and bending FF, in the specific case are given by a contact interface 16 between the peripheral walls 12″ and 13″ of the two cup-shaped elements 12, 13.

The additional mechanical strength of resistance to rotation FR between the two cup-shaped elements 12, 13 is added to that given by the frictional force existing between the opposed surfaces magnetically in contact with the two end faces A1, A2 of the magnetic core C, and the bottom walls 12′, 13′ of the two cup-shaped junction elements 12, 13, or from a particular geometric configuration of the contact interface 16 between the peripheral walls 12″ and 13″ of the same cup-shaped elements 12, 13.

In particular, the cup-shaped elements 12, 13 can have a cylindrical, prismatic or polygonal configuration of the peripheral wall 12″, 13″, such that the inner surface of the peripheral wall 12″ of the outer cup-shaped element 12 in contact with the external surface of the peripheral wall 13″ of the other cup-shaped element 13, define a contact interface 16 without mechanical clearance. A polygonal configuration of the peripheral walls 12″ and 13″ of the two cup-shaped elements 12, 13 constitutes a means for providing a high additional mechanical force FR to prevent their relative rotation; moreover, the polygonal configuration of the peripheral walls 12″, 13″ allows to change the relative angular position between the two cup-shaped elements 12, 13 and consequently of a structural element 10 with respect to the other structural element 11.

Finally, FIG. 1 shows an optional feature, consisting in the provision of sealing means between the two cup-shaped elements 12, 13 constituted, for example, by a toroidal gasket 17 housed in an annular seat of one of the two peripheral walls, for example in the peripheral wall 13″ for a total isolation of the magnetic core C from external environment, providing a suitable closure plug (not shown) for the axially aligned holes 10A and 10B of the structural element 10 and of the bottom wall 12′ of the cup-shaped element 12, through which a tool can be inserted to facilitate disengagement and ejection of the magnetic core C.

FIG. 2 shows a second solution of the magnetic and integrated mechanical anchoring device according to the invention, in which the same reference numerals of FIG. 1 have been used to indicate similar or equivalent parts.

The solution of FIG. 2 differs from the previous one of FIG. 1 for the conical configuration of the two surfaces defining the contact interface 16 between the peripheral walls 12″ and 13″ of the two cup-shaped elements 12, 13. The solution of FIG. 2, in addition to the conical surfaces of interface 16, shows, by way of example, some possible variants both for the magnetic core C and for one of the cup-shaped elements 12 and 13; in particular in the case of FIG. 2 the magnetic core C is again configured with two opposite anchoring faces A1, A2 each having a magnetic pole of a same polarity N or S, or alternatively with at least two poles of different polarities N, S angularly spaced apart (not shown); for example this can be achieved by configuring the magnetic core C with two permanent magnets 14′, 14″appropriately polarized in the opposite direction, separated by a spacer 14A of magnetically non-conductive material. The solution of FIG. 2 provides the same magnetic and mechanical forces of the solution of FIG. 1, suitable to increase the resistance to external stresses and to prevent one or more relative movements between the two cup-shaped elements 12, 13; in this case the conical configuration of the interface 16 provides an automatic compensation of any mechanical clearance due to possible machining tolerances.

The solution of FIG. 3 in turn differs from the previous ones in that now the two cup-shaped elements 12, 13 each have mechanical interconnection members consisting of opposite front teeth T1, T2, each of which extends for part or for the entire length of the opposite edges of the side walls 12″, 13″, wherein the front toothing of one of the cup-shaped elements engages with the front toothing of the other cup-shaped element to prevent any relative rotational movement; the use of the two front toothing T1 and T2 along part or for the entire edge of the two cup-shaped elements 12, 13 also allows to change their relative angular position, and consequently the angular orientation of two structural elements 10, 11 of the assembly. Therefore, also in FIG. 3 the same reference numbers as in the previous figures have been used to indicate similar or equivalent parts.

Finally, it should be noted that in FIG. 3 the additional mechanical forces to resist to bending strength, in this case are provided by the peripheral contact surfaces of the interface 16 between the skirt 15 of the magnet 14 and the two cup-shaped elements 12, 13, as shown; moreover in FIGS. 1 and 3 with the dashed lines M′ and M″ the closed magnetic fluxes circuits have been indicated, in an assembled condition.

FIG. 4 shows a fourth solution in which the reference numbers of the preceding figures have again been used to indicate similar or equivalent parts. In the case of FIG. 4, unlike the previous cases, the two cup-shaped junction elements 12, 13 are configured with identical threads 12A and 13A which can be engaged by screwing, and which are suitable to provide an additional mechanical force FTR acting in the same axial direction of the magnetic tensile strength FM generated by the magnetic core C. Both cup-shaped elements 12, 13 can be firmly fixed to the respective structural elements 10, 11 in the case where it is possible to rotate a structural element 10 with respect to the other 11; otherwise, as shown, one of the cup-shaped elements, for example the cup-shaped element 13 can be rotatably connected with respect to its own structural element 11 by means of a screwable ring nut 13C.

In particular in the example of FIG. 4, the peripheral wall of the inner cup-shaped element 13 is configured with an external thread 13A suitable for engaging, by screwing, with a corresponding internal thread 12A of the other cup-shaped element 12, defining in this way a contact interface 16.

It should also be noted that in the various Figures, 10A and 10B indicate two axially aligned holes, in the structural element 10, respectively in the corresponding cup-shaped element 12; the holes 10A and 10B allow the introduction of a possible tool, by which it is possible to eject the magnetic core C, if of a permanent type, from one of the cup-shaped elements, or magnetically activate and deactivate the magnetic core C, if of the type further described, when it is necessary to assemble and disassemble the two structural elements 10, 11 of the assembly.

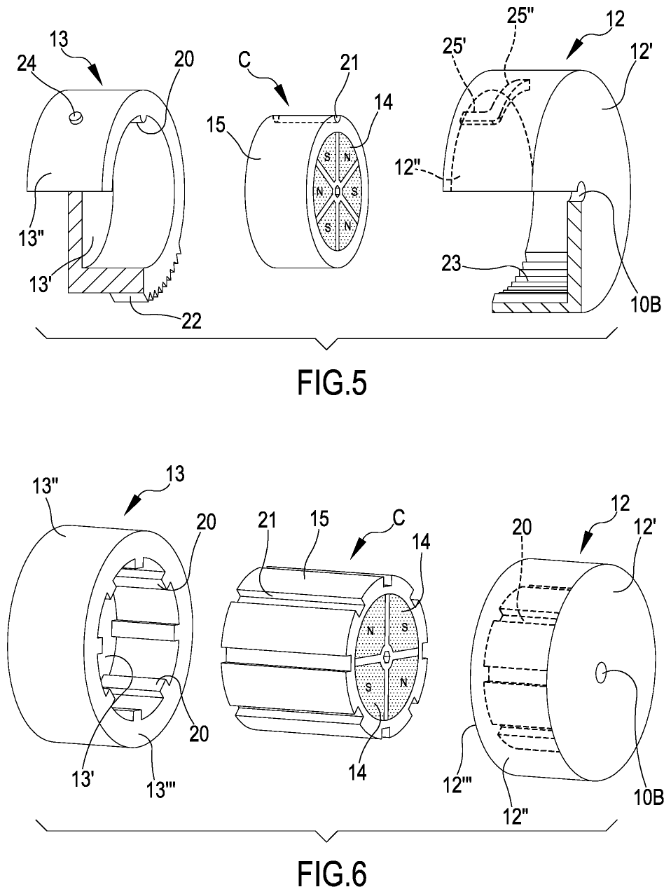

FIG. 5 shows a fifth solution similar to that of FIG. 1, in which the same reference numerals have been used again to indicate similar or equivalent parts and in which the cup-shaped elements 12, 13 can be inserted again one in the other. The solution of FIG. 5 differs from FIG. 1 in that the two cup-shaped elements 12, 13 and the skirt 15 of the magnet 14, by way of example, have been configured with different alternative mechanical means suitable to provide additional anti-rotation forces FR to prevent a relative rotational movement of a cup-shaped element with respect to the other, or a mechanical tensile strength FTR of the type indicated in FIG. 1A.

With reference to FIG. 5, the two cup-shaped elements 12, 13, instead of the front toothing F1, F2 of FIG. 3, can each have teeth of mutual engagement which extend longitudinally on the interface surfaces of the two side walls, such as mechanical connection members. In particular, the side wall 13″ of the inner cup-shaped element 13 is configured with a longitudinal toothing 22 on its outer wall which engages with a corresponding longitudinal toothing 23 on the inner surface of the side wall 12″ of the cup-shaped outer element 12; the longitudinal toothings 22, 23 can extend for part or for the entire axial length of the surfaces 12″, 13″ of the respective cup-shaped elements 12, 13.

Still with reference to the example of FIG. 5, in place of the longitudinal teeth 22, 23, the two cup-shaped elements 12, 13 can be configured with mechanical bayonet-type interconnecting members to provide a mechanical tensile strength FTR, added to the magnetic force FM; for example the outer surface of the side wall 13″ of the cup-shaped element 13 can be configured with a pin 24 able to engage with an L-shaped slot 25′, 25″on the inner surface of the side wall 12″ of the outer cup-shaped element 12, or vice versa. In particular, the L-shaped slot has a first linear section 25′ which extends from the edge of the side wall 12″ for a predetermined length parallel to the longitudinal axis of the cup-shaped element 12, in which the linear section 25′ is connected to an arcuate section 25″ parallel or slightly inclined towards the bottom wall 12′ of the same cup-shaped element 12. Also in this case, one of the two cup-shaped elements 12, 13 can be rotatably connected to the respective structural element 10, 11, as in FIG. 4.

Again the bottom wall 12′ 13′ of one or both cup-shaped elements 12, 13 for housing the magnetic core C can have an axial hole 10B for the introduction of a tool.

On the basis of the above, a first anti-rotational means consists of configuring the internal surface for example of the cup-shaped element 13 with at least one longitudinal rib 20 suitable for engaging, by sliding, in a corresponding longitudinal slot 21 on the outer surface of the skirt 15 of the magnetic core C, as additional mechanical interconnection members; an inverted configuration of the rib 20 and of the groove 21 with respect to that shown is also possible.

FIG. 6 shows a sixth solution in some ways similar to that of FIG. 5; therefore also in FIG. 6 the same reference numbers of FIG. 5 have been used to indicate similar or equivalent parts.

The solution of FIG. 6 differs from FIG. 5 in that the two cup-shaped elements 12, 13 do not penetrate one another, but are configured in such a way that the front edges 12″′ and 13″′ can be in contact between them, or being axially spaced apart, while still allowing the obtainment of the additional mechanical forces FT, FF and FR referred to above, by means of a suitable configuration of the cup-shaped elements 12, 13 and of the skirt 15 of the magnetic core C.

In particular in the case of FIG. 6, both cup-shaped elements 12, 13 are identically configured with a plurality of longitudinal ribs 20, angularly spaced apart from each other by a constant pitch, on the inner surface of the respective side wall 12″, 13″, to which corresponds a plurality of angularly spaced apart longitudinal slots 21 of the same pitch, on the outer surface of the skirt 15 of the magnetic core C, as mechanical connection members.

The presence of a plurality of ribs 20 and slots 21 angularly spaced apart of a same pitch, in addition to providing a high anti-rotational force FR, allow the relative angular orientation between the two cup-shaped elements 12, 13 to be changed with great freedom, consequently of the respective structural elements 10, 11 of an assembly; as an alternative to the constant angular pitch of the ribs 20 and of the recesses 21 referred to previously, the pitch of the ribs 20 could be a multiple of the pitch of the slots 21.

It should also be noted that in the case of FIG. 6 the magnetic core C is configured with a plurality of angularly spaced magnets 14, axially polarized with poles alternatively of opposite polarity N, S to both opposite faces A1 and A2, in which the axial length of the magnetic core C is equal to the sum of the axial lengths of the cavities of the two cup-shaped elements 12, 13, or higher, depending on different use requirements.

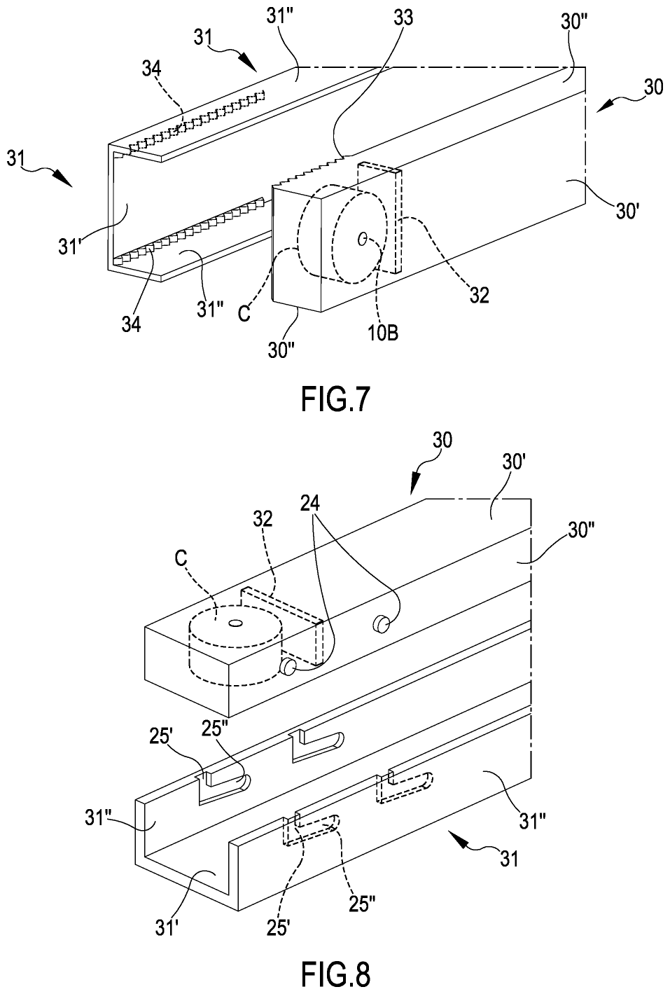

FIG. 7 shows a seventh solution which differs from the previous ones in the linear configuration of the two junction elements suitable for housing one or more magnetic cores C of the type described above.

FIG. 7 indicates a first junction element 30 of magnetically conductive material, consisting of a channel-shaped section, having a bottom wall 30′ and peripheral walls 30″ which extend along a longitudinal axis, on the two sides of the channel-shaped section 30; FIG. 7 also indicates a second junction element 31 again constituted by a channel section in magnetically conductive material, configured with a bottom wall 31′ and with peripheral walls 31″ which extend along an longitudinal axis on the two sides, parallel to the longitudinal axis and to the peripheral walls 30″ of the first channel shaped 30.

The distance between the outer surfaces of the two peripheral walls 30″ of the channel-shaped section 30 is substantially equal to the distance between the inner surfaces of the peripheral walls 31″ of the second channel-shaped section 31, so that the first channel-shaped section 30 can be inserted inside the second channel-shaped section 31, slid longitudinally, magnetically and mechanically locking the two channel-shaped sections 30, 31 in any longitudinal position.

The first channel-shaped section 30, in correspondence with the magnetic anchor core C, or of each magnetic core associated with it, can be configured with one or more internal partition walls 32 defining a housing seat for a respective magnetic core C, as schematically shown; in this way, any relative displacements of the magnetic core C are prevented, longitudinally to the section 30.

The solution of FIG. 7, with respect to the previous ones, therefore allows to change and adjust, by simple sliding, the longitudinal position of one junction element with respect to the other. In order to prevent a junction element from being able to move longitudinally with respect to the other one after coupling the two junction elements 30, 31 and after the longitudinal adjustment, both junction elements 30 and 31 can be provided with interlocking teeth. For example, the junction element 30 near the bottom wall 30′ along the edge of one or both side walls 30″ is configured with a first internal toothing 33, while the other junction element 31, in proximity of the bottom wall 31′ is configured with a second toothing 34 complementary or identical to the toothing 33; the toothings 33 and 34 extend on part or along the entire length of the two junction elements 30, 31. Also the solution of FIG. 7 is able to provide a magnetic anchoring force, and one or more additional mechanical forces previously described, to resist external stresses and to prevent one or more relative movements between the two junction elements 30, 31 in their assembled condition.

FIG. 8 shows an eighth solution, in some ways similar to that of FIG. 7, in which two channel-shaped sections in magnetically conductive material are used again for the junction elements 30 and 31; therefore in FIG. 8 the same reference numerals of FIG. 7 have still been used to indicate similar or equivalent parts.

The solution of FIG. 8 differs from that of FIG. 7 in that the teeth 33 and 34 of FIG. 7 have been replaced with a plurality of pins 24 on the outer side of one or both of the peripheral walls of the junction element 30, acting to engage with corresponding slots 25′, 25″ of a bayonet coupling, or L-shaped on the inner side of one or both peripheral walls 31″ of the other junction element 31, in this way the mechanical tensile strength FTR is increased, which is added to the magnetic force FM of the magnetic core C.

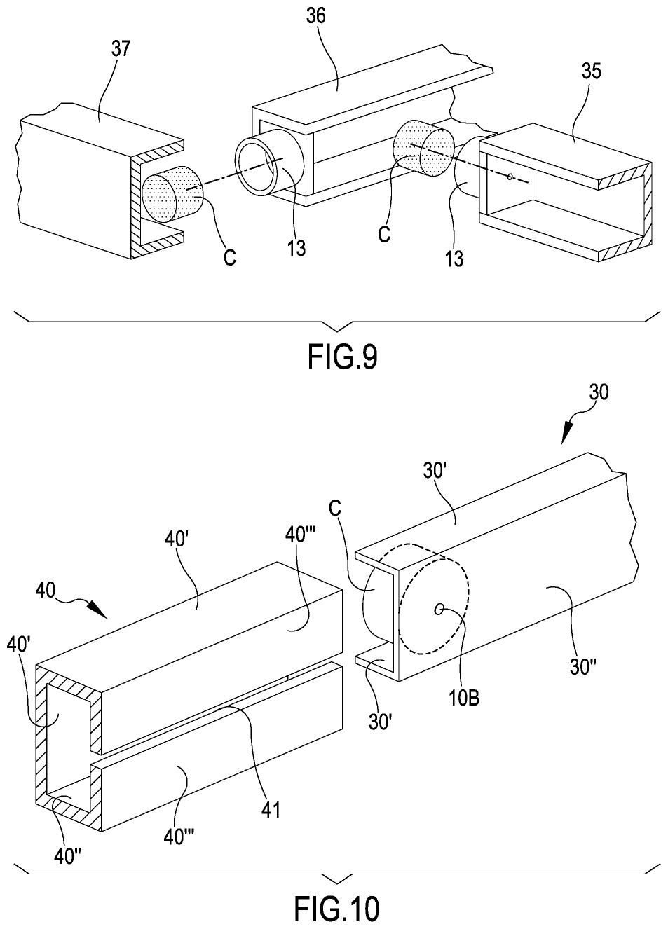

FIG. 9 shows, by way of example, the versatility of use of the integrated magnetic and mechanical anchoring device according to the invention; as shown, the anchoring device comprises a plurality of profiled jointing elements suitable for various types of frame structures. In particular FIG. 9 shows the assembly of three junction elements of the channel type 35, 36, 37 that can be positioned coplanarly, or three-dimensionally, conformable with integrated magnetic and mechanical anchoring devices of the type previously described; again in FIG. 9 some reference numbers of the preceding figures have been used to indicate similar or equivalent parts.

The solution of FIG. 9 advantageously allows to continuously adjust the relative position of each single junction element with respect to the other ones, and to assemble structures or support frames for any type of assembly.

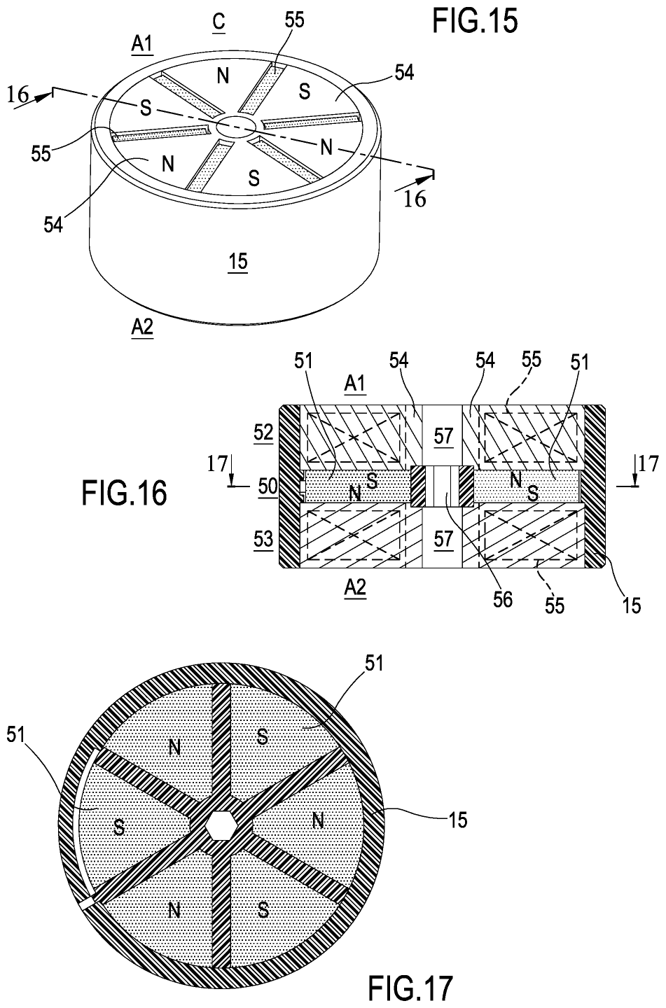

FIG. 10 shows a further solution in which a first junction element 30 consisting of a channel section substantially similar to that of FIG. 7, for housing one or more magnetic cores C (only one shown) can slide along the ‘longitudinal axis of a tubular profile 40 configured with a rectangular internal cross-section, which corresponds to the external shape of the channel section 30. The tubular section 40 is configured with a bottom wall 40′, peripheral walls 40″ on both sides, and a front wall 40′″ having a longitudinal slit 41 through which a tool can be inserted to activate and deactivate the magnetic module C in the case in which this is of the inversion or flux deviation type shown in the following FIGS. 15-17, or to eject the magnetic core C by acting with a tool through the hole 10B, in the case of a permanently magnetized type.

For the purposes of the present description, by “inversion or flux deviation” is meant a configuration of the magnetic core C comprising a plurality of fixed magnets at each anchoring face A1, A2, and a plurality of movable magnets between two operative positions, positioned and configured so as to define a first magnetic circuit which closes internally to the magnetic core itself (deactivated condition), respectively a second magnetic circuit which closes externally through the hollow housing elements, or parts thereof in magnetically conductive material (activated condition).

The solution of FIG. 10 allows a telescopic sliding of the channel section 30 in the tubular profile 40, and of continuously adjusting their relative axial position.

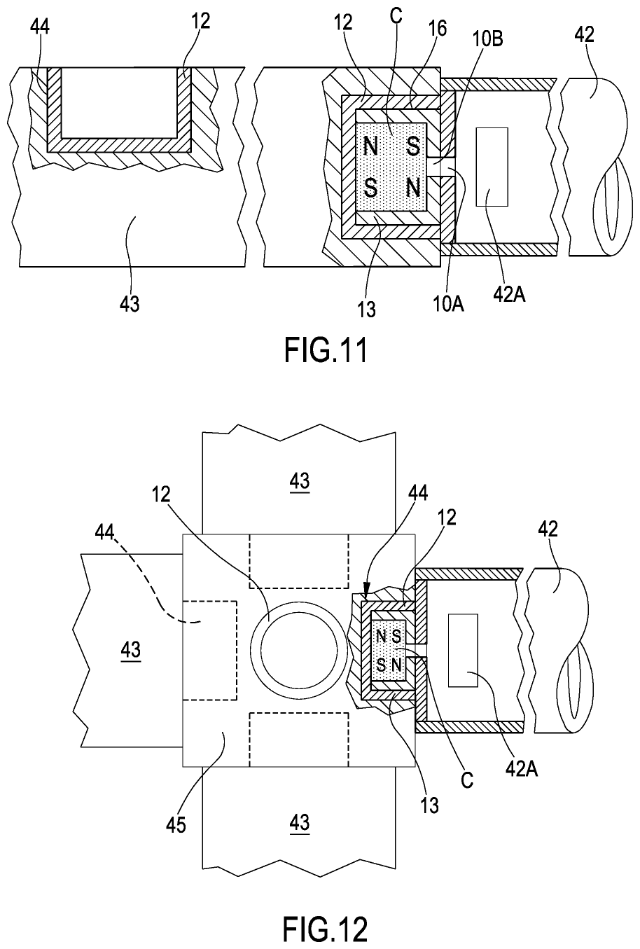

FIG. 11 shows a further example of application of the integrated magnetic and mechanical anchoring device according to the present invention; in FIG. 11 the reference numbers of the preceding figures have again been used to indicate similar or equivalent parts. In particular, FIG. 11 shows the connection of a structural element 42 of tubular shape, to one end of which a cup-shaped element 13 for housing a magnetic core C has been fixed similarly to the example of FIG. 1; the cup-shaped element 13 is inserted in a cup-shaped element 12 fixed in a housing seat provided at one end of a second structural element 43, axially aligned with the tubular element 42. As schematically shown in FIG. 11, in the case in which the second structural element 43 consists of a bar of square, rectangular or polygonal cross-section, in any type of material, for example in wood, plastic material, metal or their combination, the bar 43 can be configured with a plurality of housing seats for respective cup elements 12, on one or more sides oriented orthogonally to the longitudinal axis of the bar 43; this allows a magnetic anchorage and a mechanical connection with more structural elements 42 or other equivalent structural elements. In FIG. 11 with the reference number 42A a side window has been indicated to allow the introduction of a tool in the holes 10B, 10A, as already mentioned.

FIG. 12 shows, again by way of example, the use of a cubic connection element 45, configured on two or more sides with a seat 44 for housing a cup-shaped element 12 of the type described, to allow a magnetic anchorage and a mechanical connection with a corresponding cup-shaped element 13 for housing a magnetic anchor core C very similar or equivalent to that previously described, in which the cup-shaped element 13 is fixed, for example, to a structural element 42 or 43 of the type shown in FIG. 12.

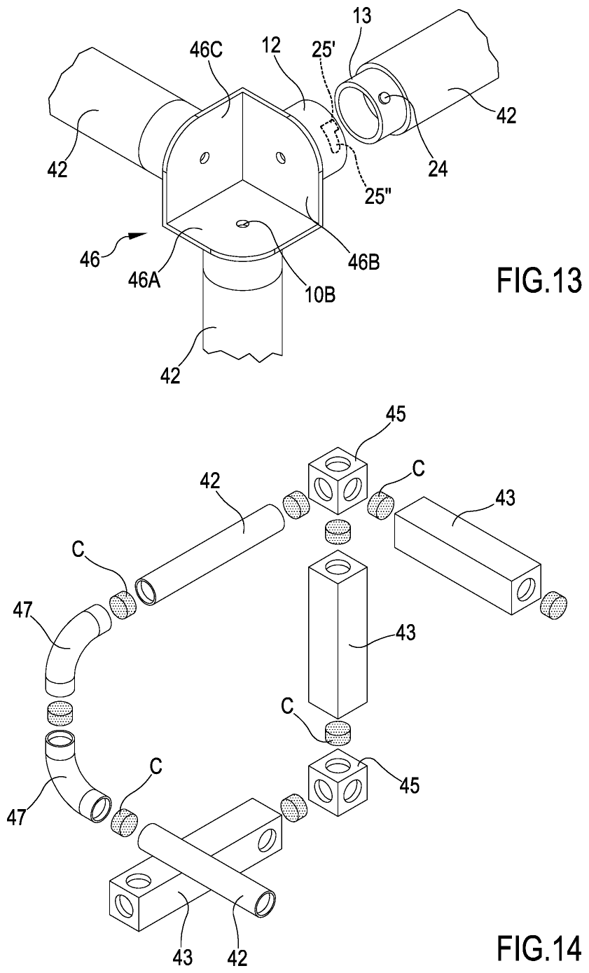

FIG. 13 shows another type of connection element for structural elements 42, by means of respective integrated magnetic and mechanical anchoring devices according to the present invention; therefore, also in FIG. 13 the same reference numbers as in the previous figures have been used to indicate similar or equivalent parts.

As shown, in the case of FIG. 13 use is made of a connection element 46, configured to connect three structural elements 42, of the type shown in FIGS. 11, 12, or other structural element, in which the structural elements 42 are differently oriented according to different axial directions. In particular, the connection element 46 is configured with three flat walls 46A, 46B, 46C arranged along three orthogonal planes; each flat wall of the connection element 46 is provided on the outer side with a cup-shaped element 12 magnetically and mechanically connectable to a corresponding cup-shaped element 13 of the type shown in FIG. 1, or of another type. Also in this case the two cup-shaped elements 12 and 13 may also be provided with a mechanical connection device of the bayonet type 24, 25′, 25″, or other type.

FIG. 14 again shows, by way of example, a possible combination of a plurality of structural elements, differently configured, which can be connected, assembled and disassembled making use of any of the magnetic and mechanical integrated anchoring devices previously described.

In particular FIG. 14 shows the combination of structural elements 42 of tubular shape, with structural elements in the shape of a bar 43, with structural elements 47 of angular shape, and with cubic connection elements 45, magnetically and mechanically connected by magnetic cores C housed in respective cup-shaped elements of the type previously described.

The following FIGS. 15 to 19 show further examples of magnetic cores C suitable for a magnetic and mechanical integrated anchoring device according to the invention.

FIGS. 15, 16, 17 show a particular magnetic module that can be activated and deactivated by reversing or deflecting the flux, as previously referred to.

Briefly, the magnetic module comprises an outer skirt 15 of magnetically non-conductive material, in which a magnetic core C of reverse flux or deviation type is housed, having two end anchoring faces A1, A2, which can be magnetically activated and deactivated.

In the example shown, the magnetic core C consists of a disc-shaped rotor 50, rotatably supported by the outer cylindrical skirt 15 in an intermediate plane, to rotate angularly between two different operative positions, according to a longitudinal axis of rotation. The rotor 50 is constituted by a plurality of permanent magnets 51, for example of triangular shape, angularly spaced apart by a constant pitch; the magnets 51 are polarized parallel to the longitudinal rotational axis so as to present on two opposite sides of the rotor 50 a plurality of magnetic poles alternatively of opposite polarity N and S.

The rotor 50 is interposed between two stators 52, 53, each of which is fixed internally to the skirt 15 and is configured with an identical plurality of induced polar elements 54, angularly spaced apart, of triangular shape identical to that of the permanent magnets 51; between the induced polar elements 54 of each stator 52, 53 there is interposed a plurality of permanent magnets 55 polarized in a direction orthogonal to the longitudinal rotational axis of the rotor 50. The magnets 55 on the two opposite sides of each polar element 54 are in contact with the polar element 54 with magnetic poles of a same polarity N or S; in this way, in an activated condition of the magnetic module C, each anchoring face A1, A2 of the two stators 52, 53 has a plurality of alternatively induced poles of appropriate polarity N, S, as shown in FIG. 15; by rotating the rotor 50 by an angle equal to the angular pitch of the magnets 51, the polarities of the magnets 51 facing the induced polar elements 54 are inverted with respect to the activated condition; in this way the magnetic flux generated by the magnets 51 and 55 circulates only inside the magnetic core C, deactivating the magnetic poles on the two faces A1, A2. The rotor 50 can be moved angularly by means of a suitable tool (not shown) inserted in a central hole 56 having a polygonal shape, through holes 57 of the two stators 52, 53 axially aligned with the polygonal hole 56 of the rotor 50.

As an alternative to the single rotor 50, the magnetic module C can comprise two opposite rotors similarly configured to the rotor 50, in which at least one linking and flux short-circuiting ferromagnetic yoke is interposed between the two rotors. In both the solutions referred to, in the activation phase of the two anchoring faces A1, A2 of the magnetic module C, the intensities of the magnetic flux generated by the magnetomotive forces placed in series of the various permanent magnets, are added together concentrating in the induced poles 54, and by short-circuiting them in two specific anchoring areas of magnetically conductive material of the cup-shaped elements, or of housing sections forming part of the magnetic and mechanical anchoring device according to the present invention.

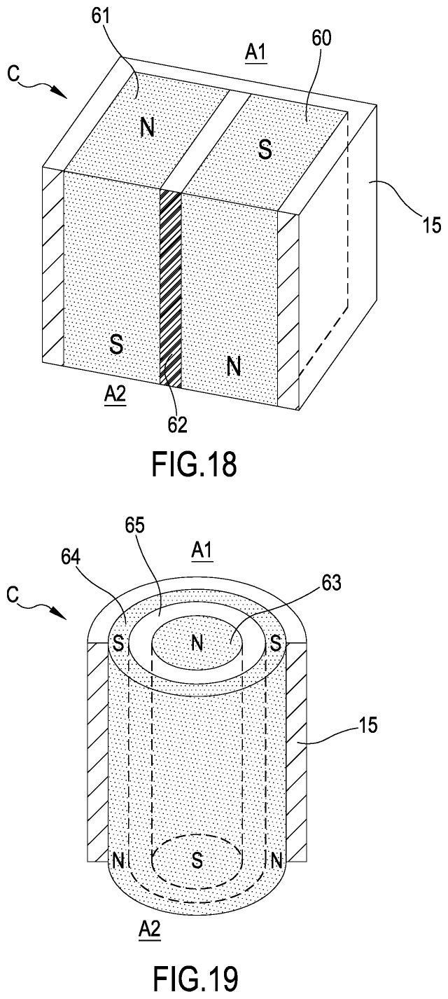

FIGS. 18 and 19 show, by way of example, other possible embodiments of a permanent magnetic core C, having at least two poles of opposite polarity N and S on the two end anchoring faces A1 and A2.

In the case of FIG. 18 the magnetic core C comprises two permanent magnets 60, 61 of rectangular shape, axially biased in mutually opposite directions, with polarity N, S, respectively S, N as shown; the two magnets 60, 61 are separated by an intermediate partition of magnetically non-conductive material, and are housed into an outer skirt 15 of magnetically non-conducting material delimited by flat external surfaces, for example of square, rectangular or polygonal shape.

FIG. 19 still shows another type of permanent magnetic core C of cylindrical shape, consisting of a first central cylindrical magnet 63 polarized axially with poles of opposite polarity N and S at the two ends; by a second annular magnet 64 polarized axially in the opposite direction to that of the central magnet 63, in which the two magnets 63, 64 are separated by an intermediate annular partition 65 of magnetically non-conducting material; the whole is housed into a tubular skirt 15 of magnetically non-conductive material. As an alternative to the magnetic cores described with reference to FIGS. 15-19, any other type of differently configured magnetic core can be used, provided that it is suitable for a similar use in a magnetic and integrated mechanical anchor device of the present invention.

1. An integrated magnetic and mechanical anchoring device, suitable for disengageably connecting structural elements of an assembly, the anchoring device including:
a first and a second junction element, configured with a bottom wall and with a peripheral wall which can be connected to a respective one of the structural elements of the assembly;
the first and the second junction element also being provided with interconnection members which can be engaged and disengaged from one another;
wherein at least the back wall of the first and second junction element is in a magnetically conductive material;
wherein a permanent magnetic anchor core, provided with at least one magnetic pole at opposite ends, extends axially and is magnetically connectable to the bottom walls in magnetically conductive material of the first and second junction element; and
wherein the first and second junction element and the magnetic anchor core are provided with respective peripheral contact interfaces, configured to increase the resistance of the anchoring device to one or more external stresses and to prevent relative movements between the first and the second junction element, in an assembled condition thereof.

2. The integrated magnetic and mechanical anchoring device according to claim 1, comprising mechanical connection members between junction elements, configured to prevent the junction elements, in an assembled condition, separately or in combination, relative movements in a longitudinal direction of the magnetic anchor core, relative movements in transverse directions, traction, bending and rotational movements with respect to the longitudinal axis of the magnetic anchor core.

3. The integrated magnetic and mechanical anchoring device according to claim 1, wherein the junction elements include cup-shaped elements mutually opposite each other and configured for housing the magnetic anchor core, and wherein each cup-shaped junction element comprises a bottom wall integral with a peripheral wall of cylindrical or polygonal shape.

4. The integrated magnetic and mechanical anchoring device according to claim 3, wherein a cup-shaped element for housing the magnetic anchor core can be inserted in an axially slidable manner in the other cup-shaped element, and wherein the mechanical connection members, suitable to prevent one or more relative bending, cutting and rotational movements, consist of cylindrical, conical or polygonal interface surfaces, in contact with each other, of the peripheral walls of the cup-shaped elements.

5. The integrated magnetic and mechanical anchoring device according to claim 3, wherein a cup-shaped element can be inserted into the other cup-shaped element in an axial direction of the magnetic anchor core, and wherein the cup-shaped elements are provided with at least one additional mechanical bayonet connection system configured to prevent a relative movement in the axial direction of the magnetic anchor core.

6. The integrated magnetic and mechanical anchoring device according to claim 2, wherein the mechanical connection members suitable to prevent a relative rotational movement between the first and the second cup-shaped element include front teeth which can be engaged with each other, along opposite edges of the peripheral walls of cup-shaped junction elements.

7. The integrated magnetic and mechanical anchoring device according to claim 3, wherein housing elements for at least one magnetic anchor core include the first and the second cup-shaped connection element configured with a circular peripheral wall, and wherein the mechanical members suitable to prevent a movement in the direction of the longitudinal axis of the magnetic core, consist of threaded areas that can be engaged between them, on opposite interface surfaces of the cup-shaped elements.

8. The integrated magnetic and mechanical anchoring device according to claim 1, wherein the magnetic anchor core comprises an external skirt configured with one or more slots or longitudinal ribs, angularly spaced by a pitch, engageable with respective ribs or longitudinal slots inside the peripheral walls of the cup-shaped elements.

9. The integrated magnetic and mechanical anchoring device according to claim 3, wherein the mechanical members for connection between the cup-shaped elements include engageable longitudinal teeth, on opposite interface surfaces (16) of the cup-shaped elements.

10. The integrated magnetic and mechanical anchoring device according to claim 1, wherein the junction elements for housing at least one magnetic anchor core include a first and a second channel shaped element, or in a tubular element.

11. The integrated magnetic and mechanical anchoring device according to claim 10, wherein the junction and channel-shaped elements are configured with engageable opposite toothings in an assembled condition, which extend parallel to a longitudinal axis of each channel-shaped element.

12. The integrated magnetic and mechanical anchoring device according to claim 10, wherein the channel-shaped elements are configured with mutual mechanical interconnection members, of a bayonet type.

13. The integrated magnetic and mechanical anchoring device according to claim 1, wherein the magnetic anchor core comprises permanently polarized magnets.

14. The integrated magnetic and mechanical anchoring device according to claim 1, wherein the magnetic anchor core is of the magnetically activatable and deactivatable type by flux inversion or deviation.

15. The integrated magnetic and mechanical anchoring device according to claim 14, wherein the magnetic core with inversion or flux deviation comprises:
a first and a second fixed magnetic stator member spaced apart in a direction of a longitudinal axis, wherein each fixed magnetic stator member is configured with a plurality of polar elements having opposite sides angularly spaced apart by a constant pitch, the stator members defining a first and a second opposite front anchoring faces for the magnetic core;
a plurality of permanent magnets polarized in a direction orthogonal to the longitudinal axis of the magnetic core, positioned between contiguous polar elements, in which the permanent magnets of each fixed magnetic stator member in contact with the opposite sides of each polar element have poles of a same polarity;
as well as comprising at least one magnetic rotor rotatably supported between a first and a second operative angular position, in which the rotor is interposed between the two fixed magnetic stator members, and comprises a plurality of permanent magnets angularly spaced, polarized parallel to the longitudinal axis of the magnetic core, configured with fore and rear magnetic poles facing the first and second stator member, alternatively of oposite polarities which can be aligned to the polar elements of the fixed magnetic stator member in the first and second operative angular position of the magnetic rotor.
